(19) United States
(12) Patent Application Publication
(10) Pub. No.: US 2013/0180553 A1
(43) Pub. Date: Jul. 18, 2013

(54) DISHWASHER

(71) Applicant: Meiko Maschinenbau GmbH & Co. KG, Offenburg (DE)

(72) Inventors: Bruno Gaus, Offenburg (DE); Andreas Fallert, Kappelrodeck (DE)

(73) Assignee: Meiko Maschinenbau GmbH & Co. KG, Offenburg (DE)

(21) Appl. No.: 13/734,177

(22) Filed: Jan. 4, 2013

(30) Foreign Application Priority Data
Jan. 12, 2012 (DE) 102012000433.8

(51) Int. Cl. B08B 3/04

(52) U.S. Cl. CPC B08B 3/04
USPC 134/105

(57) ABSTRACT

The invention relates to an apparatus for the circulation and dehumidification of moist air (54) within an automatic cleaning machine (10), in particular a commercially used program-controlled dishwasher. The inventively proposed apparatus is accommodated within a cleaning chamber (12) delimited by walls (18, 20). At least one of the walls (18, 20) is cooled from outside by a medium (24). In the cleaning chamber (12) is located a blower (50). This imparts to moist air (54) sucked up from the cleaning rack (17) a flow (52, 56, 58) along the at least one wall (18, 20) cooled by a medium (24).

The invention relates to a cleaning apparatus, in particular a commercial dishwasher for dishes, glasses, kitchen utensils, medical articles, preferably to a dishwasher having a dual-circuit system and a stationary washing method. Dishwashers of this type are also referred to as program-controlled automatic dishwashers.

EP 1 881 873 B1 relates to a commercial dishwasher in which an air inlet to a wash chamber is arranged below a door and which is designed in such a way as to generate an air stream which covers the entire width of the wash region. A reflector arrangement, which produces an evenly distributed entry of the air stream into the wash region, is provided, wherein the blower is installed in the region between the air outlet from the wash chamber and the machine outlet.

EP 1 284 627 B1 relates to an apparatus for drying dishes in a dishwasher. A dish dryer comprises a condensing device for hot and humid wash chamber air, which after its dehumidification—due to condensation in an air-conducting chamber outside the wash chamber—flows back into the wash chamber through a lower situated inlet opening. Condensate collects in an intermediate store to be emptied into the wash chamber.

The air-conducting chamber is separated from a water guidance chamber, which likewise opens out into the intermediate store, by a heat exchanger surface along which the condensate runs down into the intermediate store, parallel to a partition wall, by force of gravity. Said partition wall juts between the heat exchanger surface and the inlet opening close to the bottom edge thereof into the air-conducting chamber. In this solution, the channels can take up moisture, become soiled and/or contaminated, whereby, in the extreme case, germs could make their way onto ready-washed dishes.

U.S. Pat. No. 1,226,428 relates to a fan which is arranged within a washing chamber, essentially beneath the chamber ceiling. According to the description, the fan sucks up air from outside the chamber and blows it onto the cleaning stock. The fan is configured as an axial fan, stands freely in space and has no kind of flow-conducting devices. This apparatus apparently makes it difficult to obtain a directed flow, wherein the effect remains undefined.

DE 10 2007 038 673 B3 relates to a dishwasher. The dishwasher comprises a wash chamber, in which at least one rotatable spray arm for spraying cleaning liquid is arranged. There is also provided at least one electromotive drive, which drives the spray arm. On the spray arm is located at least one air-conducting rib, which is designed to circulate the air contained in the wash chamber.

In the solutions according to U.S. Pat. No. 2,918,068 and DE 10 2008 040 745 A1, automatic dishwashers having cooled walls in order to improve the drying action are disclosed. Thus, according to U.S. Pat. No. 2,918,068, both air-cooled and water-cooled walls are known, while according to the solution in DE 10 2008 040 745 A1 walls are cooled with water. To this end, storage containers are found on the outer sides of the walls, which storage containers during a program run can be filled with cool water in order to bring about the cooling effect. A purposeful or enforced air guidance within the washing chamber in the direction of the cooled walls is not described.

### Representation of the Invention

The object of the invention is to provide an automatic cleaning machine, in particular a dishwasher having a cleaning chamber, in which the water vapor condensation is considerably improved, an evacuation of moist air into the environment of the machine is prevented, and in which the drying effect on the cleaning stock is improved by means of air circulated within the automatic cleaning machine. It is also an object of the invention to enable the cleaning stock to be dried in relatively short time, since a program run in a commercial dishwasher is substantially shorter than in a domestic dishwasher.

According to the invention, it is proposed to arrange above a cleaning rack which is present in the cleaning chamber and which receives the load to be cleaned, in the ceiling of the cleaning chamber, a circulating apparatus, in particular a blower, particularly preferably a radial blower. The circulating device, in particular configured as a radial blower, draws off moist air over the rack containing the cleaning stock and then blows out this air parallel to the ceiling, i.e. in relation to the rotational axis of a fan impeller laterally in the radial direction. The air leaving the impeller in the radial direction flows along the ceiling until it meets side walls which, apart from the chamber door through which the cleaning chamber is accessible, delimit the cleaning chamber. There the moist air is diverted and guided along the side walls down to the base of the cleaning chamber.

The inventively proposed solution requires no openings or channels which conduct the moist air out of the chamber into condensers situated outside the chamber, into the work environment, or into an on-site waste air system. By virtue of the inventively proposed solution, apart from the radial blower, its drive and its fastening in the ceiling of the cleaning chamber, a considerable reduction in components which would otherwise have to be kept available is achieved overall, such as, for example, baffle plates, air guidance channels, condensation surfaces situated outside the cleaning chamber, air coolers or the like, over which the moist air would otherwise be led. Dirtying and contamination of such surfaces and components, with the attendant risk of recontamination of the cleaning stock, is thereby precluded. Pollution of the work environment with moisture, steam and odors is likewise precluded. The radial blower is washed during the program run, so that no risk of dirtying and, in particular, no hygiene problems can arise.

The diverted moist air is cooled in the course of its circulation along the walls delimiting the cleaning chamber. To this end, at least one of the walls which delimit the cleaning chamber is cooled from outside by a medium, such as fresh water, for instance. Given temperatures in the cleaning chamber in the order of magnitude of between 50° C. and 70° C., inflowing fresh water having a temperature, for example, between 8° C. and 23° constitutes a medium with which the at least one wall which delimits the cleaning chamber can be cooled. The air flowing along the at least one cooled limit wall of the cleaning chamber is likewise cooled as it passes along the chamber-facing side of the at least one wall cooled by the medium, so that moisture can be extracted from the air on its flow path along the at least one cooled wall, which moisture is condensed on the cooled wall. After having passed along the wall, in a substantially vertically downward direction, the dried and slightly cooled air is again capable of absorbing moisture. Due to the suction action of the radial blower arranged on the ceiling of the cleaning chamber, in the base-proximate region of the cleaning chamber an air flow from the side walls to the middle, and then upward through the rack with the cleaning stock present therein, is obtained. As it flows through the rack, the air is now once again able to absorb moisture from the cleaning stock. The at least one wall cooled by a medium can be constituted by the rear wall of the automatic cleaning machine, i.e. the wall situated opposite the access door to the cleaning chamber. Moreover, there is also the possibility of subjecting the two side walls of the cleaning chamber to a cooling medium, alternatively or additionally to the rear wall. The cooling of the at least one wall delimiting the cleaning chamber is realized preferably from outside, for instance via fresh water, which is in any case later fed to the cleaning process, in particular in connection with a fresh water rinse.

In order to subject the at least one wall on its outer side to cooling medium, a medium store is attached to the wall. The medium store is connected by its one side in such a way to the outer side of the chamber wall that a good heat transfer to the wall is achieved. It is advantageous for the effect of the invention if the medium store covers largest possible shares of the walls which delimit the chamber. An advantageous embodiment is configured such that a medium store component is assigned to each wall surface to be cooled. The hydraulic connection of the individual medium stores one to another and to the hydraulics of the machine can be realized, for example, with hoses. The medium store, apart from the hydraulic connections, is of liquid-tight construction. It can be made of plastic, for example as a plastics injection molding or as a plastics blow-molded part. The medium store can be made up of one or more components. Inside the medium store, one or more channels can be molded in, for example a meandering channel, so as to influence the flow of the cooling medium.

From the energy saving aspect of the dishwasher, the positive effect is obtained that the inflowing fresh water is warmed as it cools the wall of the cleaning chamber. A large part of the energy which is present in the moist air or as wash stock heat in the chamber can thereby be recovered and is not lost to the process, for example via possible waste air channels.

Instead of a program-controlled automatic dishwasher, which is accessible, for instance, via a pivotable door, the inventively proposed apparatus for the dehumidification of moist air can also be used on hood-type dishwashers provided that, for instance, their fixedly arranged rear wall, or at least one wall of the hood configured to be movable in the vertical direction, is then cooled.

The inventive apparatus and the method can also be used on program-controlled automatic dishwashers with different configuration of the access opening to the cleaning chamber.

The blower, furthermore, instead of being fitted on the wash chamber ceiling, can likewise be fitted in a side wall. The guidance of the air in the cleaning chamber and the arrangement of the walls to be cooled is then adapted to the altered positioning of the blower.

The blower, with its housing and the flow-conducting devices, is configured such that it is simple in structure, has good efficiency, optimally guides the flow and is not prone to getting dirty, or even has a self-cleaning effect. In particular, the air-guiding part of the housing of the blower configured as a radial blower is of split configuration. The upper part of the housing is now configured only half closed, i.e. the fixed guide mechanism is open downward toward the cleaning chamber. A good cleaning effect during the program run is thereby achieved by fresh water or cleaning fluid circulated in the chamber. The base is attached to the fan impeller, so that the base jointly rotates. The risk of dirtying can thereby be reduced, since any clinging dirt, because of the rotation of the impeller, is flung off by the effect of centrifugal force. In particular, the air channels of the rotary impeller of the radial blower can be sprayed out during the program run and thus cleaned of any clinging particles and/or dirt accumulations. By virtue of the inventively proposed solution, it is possible to dispense with a guide mechanism in traditional, closed construction, with which a diversion of the circulating moist air into automatic cleaning machines would otherwise have to be implemented. Only aligned outlet openings are provided on the fixed housing part, to enable the air issuing radially from the impeller to be guided purposefully along the at least one cooled wall which delimits the cleaning chamber. The housing and the impeller are configured such that no puddles of liquid remain. In particular, self-draining is ensured. The geometry of channel edges is optimized such that noise emission as the program is running is minimized within the cleaning chamber. A contact sealing of the drive shaft of the impeller of the radial blower can be aided, for instance, by means of a labyrinth seal in the form of a screw thread. In particular, the housing and the impeller of the radial blower can be produced from lye-resistant plastic or from CrNi steel in order to increase the working life. It can further be provided to fasten a connection-ready radial blower to the ceiling by means of a sealing flange either from inside, i.e. from the inner side of the cleaning chamber, or to introduce the radial blower into the ceiling of the cleaning chamber from outside.

Below, a procedure which is possible in the cleaning chamber is sketched: Firstly, a loading of the rack by the user and a following closure of the cleaning chamber door are realized. After this, the user selects a program which is due to run in the cleaning chamber. After the start of the program, the washing operation takes place, which is followed by a draining phase. The radial blower starts up, lye residues and any residual dirt which might be present are flung off from the impeller. This is followed by a rinse, in the course of which the radial blower continues running. As soon as the rinse is ended, the medium store is filled with a medium, for example inflowing fresh water with a temperature of about 8° C. to 23° C., on at least one of the walls which delimit the cleaning chamber. The fresh water remains in the medium store and the fan carries on running for a defined period which can be, for instance, 150 s. Following expiry of this period, the program is ended. This is signaled to the user, for example, by an optical and/or acoustic signal. After this, the user can open the washing chamber door without a wave of moist, warm air streaming toward him. The user can remove the rack, with the cleaned and dried stock, from the cleaning chamber.

At the end of the program, the slightly warmed fresh water from the medium store, which has been warmed by the moist air flowing along the cooled wall on the inner side of the cleaning chamber, is fed to a heat exchanger, for example a boiler, and is further warmed therein for the next program run. In the following program run, this warmed fresh water is then used for the rinse. Optionally, for the clear rinse, rinse aid can be added to the fresh water to improve the wetting of the cleaning stock and the draining of the liquid therefrom. The metered addition can take place, for instance, in the boiler.

In an alternative run of the washing program running in the cleaning chamber of the automatic cleaning machine, a loading of the cleaning chamber with a dish rack and a closure of the cleaning chamber door are firstly realized by the user. When the program is started by the user, the latter can actively deselect the drying function. After this follows the running of the washing operation, with cleaning chamber door closed, within the cleaning chamber. The cleaning phase is followed by a drainage phase, in which the radial blower starts up and any clinging lye residues and/or residual dirt are flung off, as already described in the above. The drainage phase is followed by a rinse, during which phase the radial blower likewise runs. Following ending of the rinse, the medium store, on the at least one wall which delimits the cleaning chamber, is not filled with cold medium, but rather this medium is led directly into the heat exchanger, for instance a boiler. This program alternative is appropriate when, due to high volume of cleaning stock, for example, the time period which is necessary for the drying would adversely affect the operating procedure. Through the selection of this option, the at least one medium store on the at least one wall is not filled with cold water, and hence nor is the wall cooled. This avoids a situation in which, in a directly following wash program, the temperature of the dishwasher liquid substantially falls as a result of a heat exchange of the dishwasher liquid onto the at least one cooled wall, which would unnecessarily lengthen the running time of the program.

A further special case in the operation of the drying device is described below. If the wash chamber door is opened during the already started drying phase, the drying process is ended and the radial blower is switched off. The medium store on the at least one wall, which has already been wholly or partially filled with cold medium, is then emptied into the heat exchanger, for example the boiler. If the boiler, after emptying of the side walls, is not yet fully filled, then it is filled directly, with by-passing of the side walls. This avoids a situation in which, in a directly following wash program, the temperature of the dishwasher liquid substantially falls as a result of a heat exchange of the dishwasher liquid onto the at least one wall filled with cold medium, which would unnecessarily lengthen the running time of the program.

A further alternative program run is possible if, in respect of the cleaning program, particular demands are placed upon hygiene, and therefore the heat transfer into the cleaning stock has to be monitored or improved. To this end, the at least one medium store, following ending of the cleaning and rinse steps, is initially not filled with cold medium. The blower starts up, so that the air/steam mixture is circulated in the cleaning chamber and so can deliver its heat evenly to the cleaning stock. In this additional program step, the cleaning stock gathers additional heat equivalent, which can then be used to assess the achieved hygienization. Such hygienization methods are described, for example, in the A0 process or in the NSF Standard 3. Following the completed hygienization of the cleaning stock, the at least one medium store is filled with cold fresh water and the drying step proceeds as described above.

### Advantages of the Invention

The advantages of the inventively proposed solution can be seen, above all, in the fact that an escape of hot moist air upon opening of the, for instance, pivotably configured door which closes off the cleaning chamber is prevented. A recovery of energy contained in the moist air being circulated within the cleaning chamber is realized, since the heat contained in the moist air, on the cooled wall, transfers to the wall-cooling medium and is used to preheat this same prior to passage through the heat exchanger. Through the use of a blower, the circulation of the moist air is enforced, which leads to a significantly improved heat transfer and a consequential shortening of the cooling and drying phase, and thus of the program running time. At the end of the program, dry dishes or cleaning stock is present within the cleaning chamber. When the wash chamber door is opened, no dampening of the machine environment takes place. The devices with which the drying and dehumidification of the moist air is realized within the cleaning chamber are regularly cleaned during the cleaning program running in the cleaning chamber, so that contamination and hygiene problems are precluded. In comparison to previously known solutions of the prior art, a substantially smaller number of components are necessary for the realization of the inventively proposed solution.

A further advantage of the inventively proposed solution lies in the fact that, if the chamber door is opened in the drying phase, this is aborted and the cold walls which are not yet fully filled with the heat-transferring medium are re-emptied. This facility, together with the facility to choose between with or without drying phase, i.e. without cooling of the chamber, represents a significant advantage for the user.

### BRIEF DESCRIPTION OF THE DRAWING

The invention is described in greater detail below with reference to the drawing, wherein:

FIG. 1 shows a section through an automatic cleaning machine, in particular an automatic cleaning machine having a cleaning chamber, and

FIG. 2 shows a representation of the circulating moist airflow of the radial blower.

### EMBODIMENTS

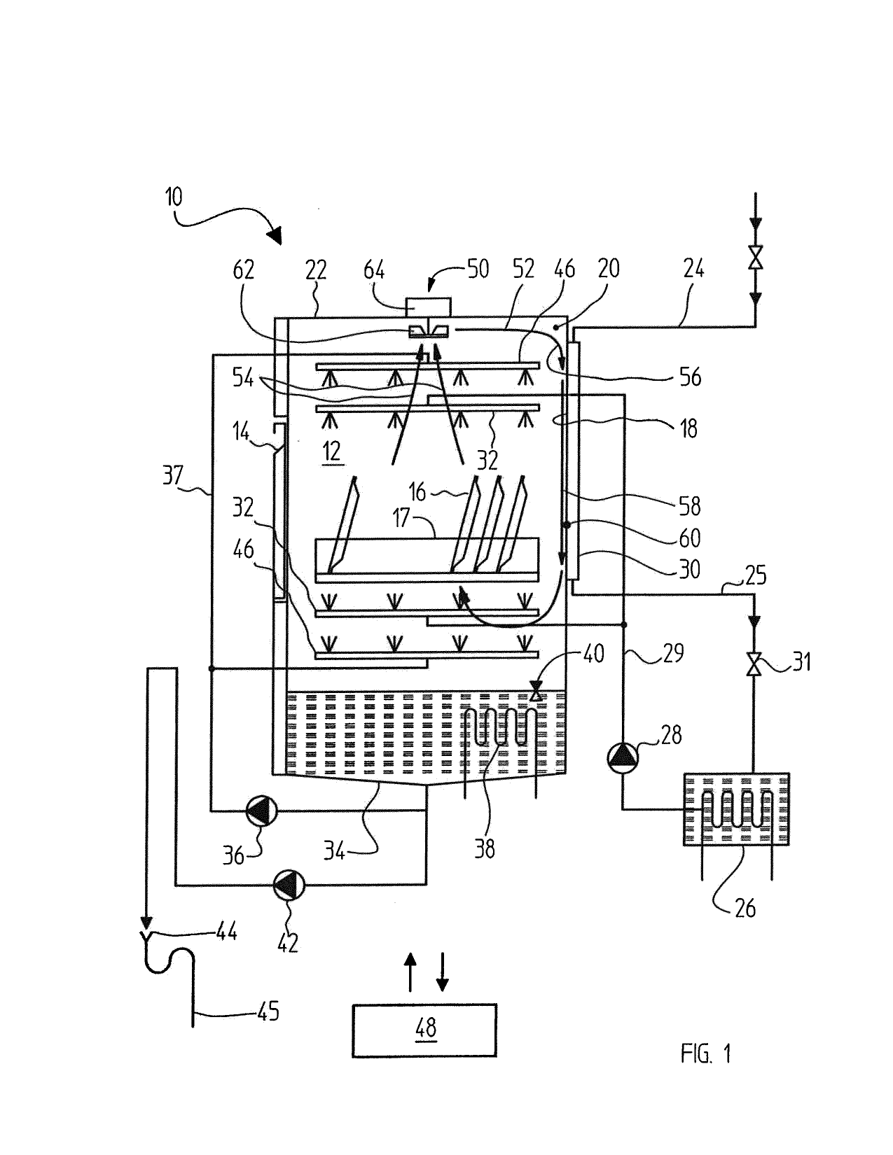

From the representation according to FIG. 1 can be seen a section through an automatic cleaning machine, in particular an automatic cleaning machine having a cleaning chamber containing a radial blower.

As can be seen from FIG. 1, an automatic cleaning machine is configured, in particular, as a program-controlled dishwasher 10. The program-controlled dishwasher 10 comprises a cleaning chamber 12, which is accessible via a pivotably arranged cleaning chamber door 14. Within the cleaning chamber 12 is accommodated a rack 17, in which the stock 16 to be cleaned, for instance glasses, dishes, cutlery, containers, medical appliances and the like, are received. The cleaning chamber 12, which is accessible via the pivotably arranged cleaning chamber door 14, is delimited by a rear wall 18 and side walls 20. The top side of the cleaning chamber 12 is formed by a ceiling 22.

From the representation according to FIG. 1, it is evident that a medium store 30 is arranged on the rear wall 18 of the cleaning chamber 12. The better is executed the heat transfer between the inner side of the medium store and the outer side of the wall, the better is the effect of the system. In the embodiment according to FIG. 1, the medium store 30 is flowed through by fresh water 24, which can have, for instance, a temperature between 8° C. and 23° C. according to weather conditions and the course of the piping. The fresh water 24 flows through the medium store 30, which is arranged on the outer side of the rear wall 18 of the cleaning chamber 16 by means of a heat-conducting connection, from top to bottom in the vertical direction. At the discharge end of the medium store 30 is found, in a fresh water line 25, a drain valve 31. After the fresh water 24 has passed through the medium store 30, it is heated within the heat exchanger 26, for instance a boiler, and is led by means of a clear rinse pump 28 via the clear rinse line 29 into the cleaning chamber 12. The fresh water is applied via thereto assigned spray arms 32, from the top side and from the bottom side, to the cleaning stock 16 stored in the rack 17.

For the clear rinse, rinse aid can optionally be added to the fresh water in order to improve the wetting of the cleaning stock and the draining of the liquid from the cleaning stock. The metered addition can take place, for instance, into the boiler 26. In FIG. 1, this optional system is not represented.

In addition, the program-controlled dishwasher 10 comprises on the bottom side of the cleaning chamber 12 a container for cleaning fluid 34, in which the cleaning fluid is stored. In this, a heat exchanger, indicated in FIG. 1 by the reference symbol 38, can be accommodated. A level which the cleaning fluid 34 assumes in the program-controlled automatic dishwasher 10 is denoted by the reference symbol 40. Beneath the container for cleaning fluid 34 is found a drainage line, branching off from which is a line branch to a circulating pump 36 for cleaning fluid. Via the circulating pump 36, the cleaning fluid is led to the spray arms installed within the cleaning chamber 12, compare reference symbol 46 in FIG. 1, and sprayed onto the cleaning stock 16.

An optional metering system for cleaning agent, which can supply this means to the cleaning fluid, is not represented in FIG. 1.

In addition, the drainage line comprises beneath the container for cleaning fluid 34 a pumping unit 42, with which drawn-off cleaning fluid is conveyed to a main network separation unit 44 passing into a drain 45.

The program-controlled automatic dishwasher represented schematically in FIG. 1 is operated by means of a machine control system 48, via which the user selects and starts the cleaning programs, which respectively run in the cleaning chamber 12, according to application, according to degree of dirt accumulation and according to requirement.

From FIG. 1 it is evident that a radial blower 50 is located in the ceiling 22 of the cleaning chamber 12. The radial blower 50 is found substantially on the middle of the ceiling 22 at a distance above the cleaning stock 16 contained in the rack 17. Due to the suction effect of the radial blower 50, moist air 54, upon rotation of the impeller 62, is sucked up, and is blown out in the radial direction substantially parallel to the ceiling 22. In the representation according to FIG. 1, this is indicated by a direction of circulation 52 of the moist air 54. The moist air leaving the impeller 62 in a lateral, i.e. substantially radial direction is cooled as it meets the rear wall 18 cooled by the cool medium, fresh water 24, in the medium store 30, or is diverted as it meets the side walls 20 delimiting the cleaning chamber 12, compare reference symbol 56 in FIG. 1. The air flows along cooled chamber sides 60 of the walls 18, 20 delimiting the cleaning chamber, downward in the vertical direction. As it passes along the cooled chamber sides 60, the moisture contained in the moist air 54 condenses on the at least one cooled wall 18, 20 delimiting the cleaning chamber 12. During its passage along the at least one cooled wall 18, 20, the moist air 54 is thus dehumidified and cooled. At the same time, the medium 24 flowing through the medium store 30—in the present illustrative embodiment the fresh water 24 later used for the clear rinse—is warmed before, after passing through the drain valve 31 into the heat exchanger 26, it enters, for instance, the boiler. Due to the position of the radial blower 50, on the ceiling 22, at a distance above the rack 17 receiving the cleaning stock 16, the now cooled and dehumidified air is once again sucked up by the impeller 62 of the radial blower 50 and hereupon flows through the rack 17 in which the cleaning stock 16 to be dried is accommodated.

If the running period of the radial blower 50 after the end of the program, for instance a period of 150 s, is heeded, then a not inconsiderable dehumidification of the moist air circulating with closed door 14 within the cleaning chamber 12, and thus removal of moisture from the cleaning stock, can be achieved. For the drying within the cleaning chamber, therefore, no moist air has to be conveyed out from the cleaning chamber 12, for example via evacuation channels which would otherwise have to be provided. There is therefore no adverse effect upon the environment.

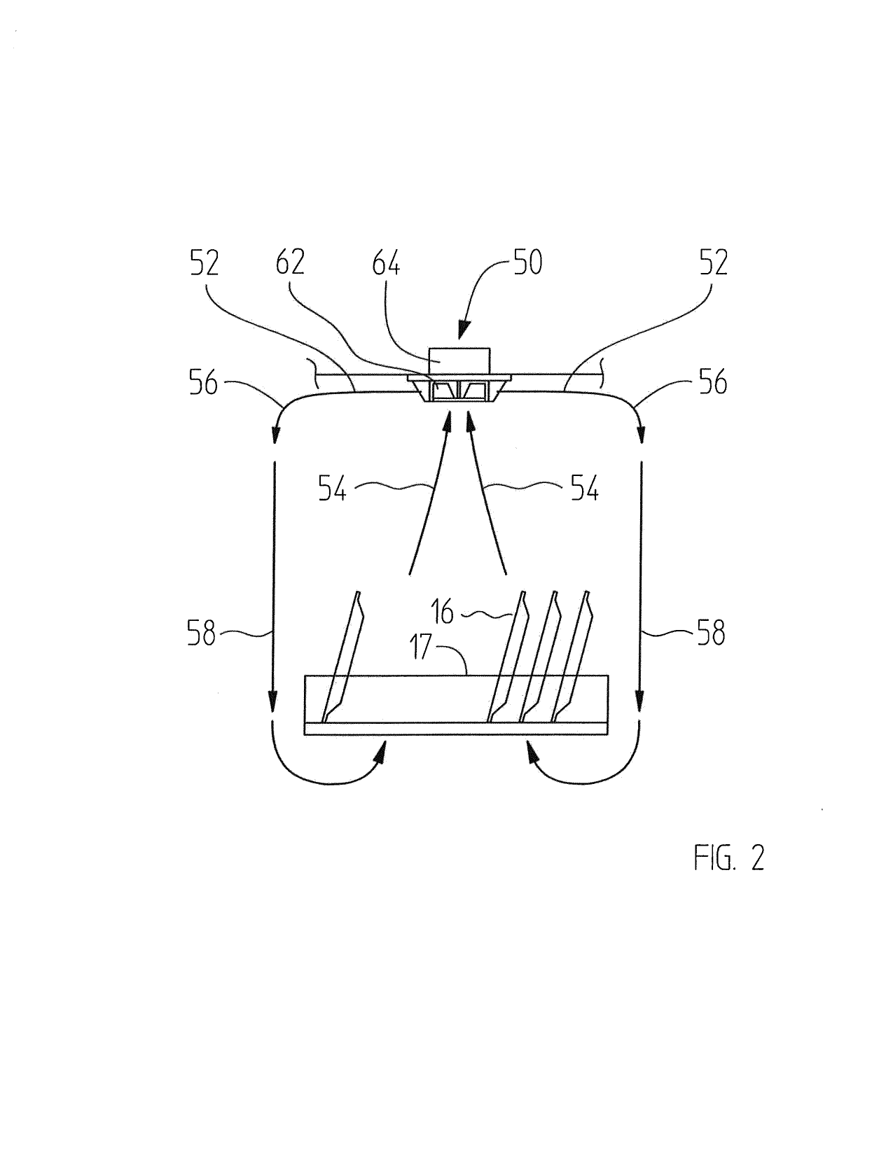

From the representation according to FIG. 2 can be seen a view of the radial blower, which according to the representation in FIG. 1 is installed in the ceiling, delimiting the cleaning chamber, of the program-controlled dishwasher.

FIG. 2 shows that the radial blower 50 has a preferably electrically configured drive 64, which is arranged outside the cleaning chamber 12. The drive 64 is connected by a drive shaft (not denoted in detail) to an impeller 62 of the radial blower 50. The impeller 62 of the radial blower 50 is located within the cleaning chamber 12 of the program-controlled dishwasher 10 according to the representation in FIG. 1. As shown by FIG. 2, the impeller 62 sucks up moist air 54 out of the cleaning chamber 12. The moist air leaving the impeller 62 of the radial blower 50 in the radial direction undergoes the flow diversion 56 on the walls of the cleaning chamber 12 and flows along the flow path 58, for instance from top to bottom in the vertical direction, i.e. from the ceiling 22 in the direction of the container for cleaning fluid 34 within the cleaning chamber 12 down along the rear wall 18, or the side walls 20 configured such that they are additionally cooled. The air flowing along the chamber sides 60 along the flow path 58 undergoes cooling and significant dehumidification. As indicated in dashed representation in FIG. 2, the air flows once again through the rack 17 which receives the cleaning stock 16 to be cleaned. Given a running period of the radial blower 50 of, for instance, 150 s and more, the inventively proposed apparatus can achieve a significant reduction in air humidity or steam vapors within the cleaning chamber 12 when the cleaning chamber door 14 is still closed. During this time, furthermore, drying of the cleaning stock is also achieved. The period for which the radial blower 50 runs can also be extended, according to requirement, to beyond the 150 s, so that, when the pivotably arranged cleaning chamber door 14 is opened, no visible steam vapors escape outward and adversely impact on the user or the environment of the program-controlled dishwasher 10.

### REFERENCE SYMBOL LIST

10 program-controlled automatic dishwasher
12 cleaning chamber
14 cleaning chamber door (pivotable)
16 cleaning stock
17 rack
18 rear wall
20 side wall
22 ceiling
24 fresh water
25 fresh water line
26 heat exchanger (boiler)
28 clear rinse pump
29 clear rinse line
30 medium store/rear wall
31 drain valve
32 spray arm for rinse
34 container for cleaning fluid
36 circulating pump for cleaning fluid
37 line for cleaning fluid
38 heat exchanger
40 cleaning fluid level
42 pumping unit for pumping-off
44 main network separation unit
45 drain
46 spray arm for cleaning fluid
48 machine control system
50 radial blower
52 direction of circulation of the moist air
54 sucked-up moist air
56 flow diversion
58 flow path
60 rear wall cooled on the chamber side
62 impeller
64 drive

1. An apparatus for the circulation and dehumidification of moist air (54) within an automatic cleaning machine (10), in particular a commercial program-controlled dishwasher accommodated within a cleaning chamber (12) partially delimited by walls (18, 20), wherein at least one of the walls (18, 20) is cooled on the outer side by a medium (24) and in the cleaning chamber (12) is arranged a blower (50) which imparts to moist air (54) within the cleaning chamber a flow (52, 56, 58) along the at least one wall (18, 20) cooled by a medium (54) and guides this in the circuit within the cleaning chamber (12).

2. The apparatus as claimed in claim 1, wherein the radial blower (50) is arranged within the cleaning chamber (12) in the ceiling (22) above the rack (17) receiving the load (16) to be cleaned.

3. The apparatus as claimed in claim 1, wherein the radial blower (50) is arranged within the cleaning chamber (12) in a side wall (20, 18).

4. The apparatus as claimed in claim 1, wherein a medium store (30) is arranged on the outer side of the at least one wall (18, 20) cooled by the medium (24) and is connected to the wall in a heat-conducting manner.

5. The apparatus as claimed in claim 1, wherein in the at least one medium store (30) flowed through by the medium (24) a meandering channel is arranged such that it covers the wall surface (60) assigned to the cleaning chamber (12).

6. The apparatus as claimed in claim 1, wherein the medium (24) is a medium, in particular cold fresh water, which is introduced directly or indirectly into the cleaning chamber (12) during running of a cleaning program.

7. The apparatus as claimed in claim 1, wherein, in a line guiding the medium (24), a drain valve (31) is arranged beneath the medium store (30).
